(19) United States
(12) Patent Application Publication
(10) Pub. No.: US 2021/0331367 A1
(43) Pub. Date: Oct. 28, 2021

(54) PLASTICIZING DEVICE, THREE-DIMENSIONAL SHAPING APPARATUS, AND INJECTION MOLDING APPARATUS

(71) Applicant: SEIKO EPSON CORPORATION, Tokyo (JP)

(72) Inventor: Megumi ENARI, Shiojiri-shi (JP)

(21) Appl. No.: 17/236,139

(22) Filed: Apr. 21, 2021

(30) Foreign Application Priority Data
Apr. 24, 2020 (JP) 2020-077193

(51) Int. Cl. B29C 45/78; B29C 45/53; B29C 45/60; B29C 45/62; B29C 45/74

(52) U.S. Cl. CPC B29C 45/78; B29C 45/531; B29C 45/74; B29C 45/62; B29C 45/60

(57) ABSTRACT

A plasticizing device includes a drive motor, a screw that is rotated by the drive motor and that has a grooved face provided with a groove, a barrel that has an opposed face opposed to the grooved face and that is provided with a communication hole communicating with the groove at the opposed face, a first heating section that heats the material supplied to the groove, a temperature sensor that measures a temperature of the groove, and a control unit that controls the drive motor and the first heating section, wherein the control unit performs a first process for rotating the screw at a first rotation speed by controlling the drive motor, and a second process for rotating the screw at a second rotation speed higher than the first rotation speed by controlling the drive motor, and the control unit controls the first heating section so that a temperature measured by the temperature sensor falls within a predetermined range when performing the first process and the second process.

The present application is based on, and claims priority from JP Application Serial Number 2020-077193, filed on Apr. 24, 2020, the disclosure of which is hereby incorporated by reference herein in its entirety.

### BACKGROUND

### 1. Technical Field

The present disclosure relates to a plasticizing device, a three-dimensional shaping apparatus, and an injection molding apparatus.

### 2. Related Art

There has been known a plasticizing device that plasticizes a material.

For example, JP-A-2010-241016 (Patent Document 1) describes a plasticizing and sending-out device including a barrel in which a material inflow path is open to one end face, a rotor having an end face that is slidably in contact with one end face of the barrel, and a spiral groove formed at an end face of the rotor. In the spiral groove, a material is supplied from a radially outer end portion, and also a radially inner end portion communicates with an opening end of the material inflow path of the barrel.

In the plasticizing and sending-out device including the rotor as described above, a material can be stably plasticized by the balance between conveyance of the material and melting of the material. Ideally, it is desirable that in a material supply portion that is the radially outer end portion of the spiral groove, the material is in a solid state, and as the material approaches the radially inner end portion of the spiral groove, the material is transformed into a molten state. For example, when the material is in a molten state in the supply portion, the molten material leaks out of the supply portion, and the material cannot be stably plasticized in some cases.

### SUMMARY

One aspect of a plasticizing device according to the present disclosure is directed to a plasticizing device that plasticizes a material, and includes
a drive motor,
a screw that is rotated by the drive motor and that has a grooved face provided with a groove,
a barrel that has an opposed face opposed to the grooved face and that is provided with a communication hole communicating with the groove at the opposed face,
a first heating section that heats the material supplied to the groove,
a temperature sensor that measures a temperature of the groove, and
a control unit that controls the drive motor and the first heating section, wherein
the control unit performs
   a first process for rotating the screw at a first rotation speed by controlling the drive motor, and
   a second process for rotating the screw at a second rotation speed higher than the first rotation speed by controlling the drive motor, and
the control unit controls the first heating section so that a temperature measured by the temperature sensor falls within a predetermined range when performing the first process and the second process.

One aspect of a plasticizing device according to the present disclosure is directed to a plasticizing device that plasticizes a material, and includes
a drive motor,
a screw that is rotated by the drive motor and that has a grooved face provided with a groove,
a barrel that has an opposed face opposed to the grooved face and that is provided with a communication hole communicating with the groove at the opposed face,
a cooling section that cools the material supplied to the groove,
a temperature sensor that measures a temperature of the groove, and
a control unit that controls the drive motor and the cooling section, wherein
the control unit performs
   a first process for rotating the screw at a first rotation speed by controlling the drive motor, and
   a second process for rotating the screw at a second rotation speed higher than the first rotation speed by controlling the drive motor, and
the control unit controls the cooling section so that a temperature measured by the temperature sensor falls within a predetermined range when performing the first process and the second process.

One aspect of a three-dimensional shaping apparatus according to the present disclosure is directed to a three-dimensional shaping apparatus that shapes a three-dimensional shaped article, and includes
a plasticizing section that plasticizes a material to form a molten material, and
a nozzle that ejects the molten material supplied from the plasticizing section to a stage, wherein
the plasticizing section includes
   a drive motor,
   a screw that is rotated by the drive motor and that has a grooved face provided with a groove,
   a barrel that has an opposed face opposed to the grooved face and that is provided with a communication hole communicating with the groove at the opposed face,
   a heating section that heats the material supplied to the groove,
   a temperature sensor that measures a temperature of the groove, and
   a control unit that controls the drive motor and the heating section, and
the control unit performs
   a first process for rotating the screw at a first rotation speed by controlling the drive motor, and
   a second process for rotating the screw at a second rotation speed higher than the first rotation speed by controlling the drive motor, and
the control unit controls the heating section so that a temperature measured by the temperature sensor falls within a predetermined range when performing the first process and the second process.

One aspect of an injection molding apparatus according to the present disclosure includes
a plasticizing section that plasticizes a material to form a molten material, and
a nozzle that injects the molten material supplied from the plasticizing section to a mold, wherein
the plasticizing section includes
   a drive motor,
   a screw that is rotated by the drive motor and that has a grooved face provided with a groove,
   a barrel that has an opposed face opposed to the grooved face and that is provided with a communication hole communicating with the groove at the opposed face,
   a heating section that heats the material supplied to the groove,
   a temperature sensor that measures a temperature of the groove, and
   a control unit that controls the drive motor and the heating section, and
the control unit performs
   a first process for rotating the screw at a first rotation speed by controlling the drive motor, and
   a second process for rotating the screw at a second rotation speed higher than the first rotation speed by controlling the drive motor, and
the control unit controls the heating section so that a temperature measured by the temperature sensor falls within a predetermined range when performing the first process and the second process.

### BRIEF DESCRIPTION OF THE DRAWINGS

FIG. 1 is a cross-sectional view schematically showing a three-dimensional shaping apparatus according to the present embodiment.

FIG. 2 is a perspective view schematically showing a flat screw of the three-dimensional shaping apparatus according to the present embodiment.

FIG. 3 is a plan view schematically showing the flat screw of the three-dimensional shaping apparatus according to the present embodiment.

FIG. 4 is a plan view schematically showing a barrel of the three-dimensional shaping apparatus according to the present embodiment.

FIG. 5 is a cross-sectional view schematically showing the three-dimensional shaping apparatus according to the present embodiment.

FIG. 6 is a flowchart for illustrating a shaping process of the three-dimensional shaping apparatus according to the present embodiment.

FIG. 7 is a cross-sectional view schematically showing a three-dimensional shaped article shaped by the three-dimensional shaping apparatus according to the present embodiment.

FIG. 8 is a plan view schematically showing a three-dimensional shaped article shaped by the three-dimensional shaping apparatus according to the present embodiment.

FIG. 9 is a cross-sectional view schematically showing a three-dimensional shaping apparatus according to a first modification of the present embodiment.

FIG. 10 is a plan view schematically showing a barrel of a three-dimensional shaping apparatus according to a second modification of the present embodiment.

FIG. 11 is a cross-sectional view schematically showing a three-dimensional shaping apparatus according to a third modification of the present embodiment.

FIG. 12 is a plan view schematically showing a flat screw of a three-dimensional shaping apparatus according to a fourth modification of the present embodiment.

FIG. 13 is a cross-sectional view schematically showing an injection molding apparatus according to the present embodiment.

### DESCRIPTION OF EXEMPLARY EMBODIMENTS

Hereinafter, preferred embodiments of the present disclosure will be described in detail using the drawings. Note that the embodiments described below are not intended to unduly limit the contents of the present disclosure described in the appended claims. Further, all the configurations described below are not necessarily essential configuration requirements of the present disclosure.

### 1. Three-Dimensional Shaping Apparatus

### 1.1. Configuration

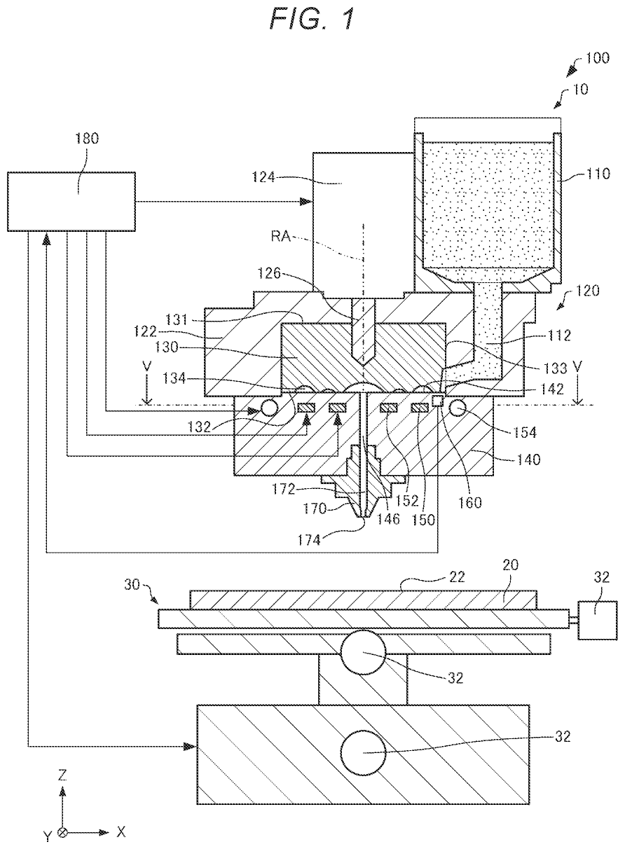

First, a three-dimensional shaping apparatus according to the present embodiment will be described with reference to the drawings. FIG. 1 is a cross-sectional view schematically showing a three-dimensional shaping apparatus 100 according to the present embodiment. Note that in FIG. 1, as three axes orthogonal to one another, X axis, Y axis, and Z axis are shown. An X-axis direction and a Y-axis direction are each, for example, a horizontal direction. A Z-axis direction is, for example, a vertical direction.

The three-dimensional shaping apparatus 100 includes, for example, a shaping unit 10, a stage 20, and a moving mechanism 30 as shown in FIG. 1.

The three-dimensional shaping apparatus 100 drives the moving mechanism 30 so as to change the relative position of a nozzle 170 of the shaping unit 10 and the stage 20 while ejecting a molten material to the stage 20 from the nozzle 170. By doing this, the three-dimensional shaping apparatus 100 shapes a three-dimensional shaped article having a desired shape on the stage 20. The detailed configuration of the shaping unit 10 will be described below.

The stage 20 is moved by the moving mechanism 30. The three-dimensional shaped article is formed at a shaping face 22 of the stage 20.

The moving mechanism 30 changes the relative position of the shaping unit 10 and the stage 20. In the illustrated example, the moving mechanism 30 moves the stage 20 with respect to the shaping unit 10. The moving mechanism 30 is constituted by a three-axis positioner for moving the stage 20 in the X-axis direction, Y-axis direction, and Z-axis direction by the driving forces of three motors 32. The motors 32 are controlled by a control unit 180.

The moving mechanism 30 may be configured to move the shaping unit 10 without moving the stage 20. Alternatively, the moving mechanism 30 may be configured to move both the shaping unit 10 and the stage 20.

### 1.2. Shaping Unit

The shaping unit 10 includes, for example, a material feeding section 110, a plasticizing section (plasticizing device) 120, and the nozzle 170 as shown in FIG. 1.

To the material feeding section 110, a material in a pellet form or a powder form is fed. As the material in a pellet form, for example, ABS (acrylonitrile butadiene styrene) is exemplified. The material feeding section 110 is constituted by, for example, a hopper. The material feeding section 110 and the plasticizing section 120 are coupled through a supply channel 112 provided below the material feeding section 110. The material fed to the material feeding section 110 is supplied to the plasticizing section 120 through the supply channel 112.

The plasticizing section 120 includes, for example, a screw case 122, a drive motor 124, a flat screw 130, a barrel 140, a first heating section 150, a second heating section 152, a cooling section 154, a temperature sensor 160, and the control unit 180. The plasticizing section 120 plasticizes a material in a solid state supplied from the material feeding section 110 so as to form a molten material in a paste form having fluidity, and supplies the molten material to the nozzle 170.

Note that the “plasticization” is a concept including melting, and when a material shows a glass transition temperature, the “plasticization” is to raise the temperature of the material to a temperature equal to or higher than the glass transition temperature, and when a material does not show a glass transition temperature, the “plasticization” is to raise the temperature of the material to a temperature equal to or higher than the melting point, and transformation into a state having fluidity from a solid is referred to as melting or plasticization.

The screw case 122 is a housing that houses the flat screw 130. To a lower face of the screw case 122, the barrel 140 is fixed, and the flat screw 130 is housed in a space surrounded by the screw case 122 and the barrel 140.

The drive motor 124 is fixed to an upper face of the screw case 122. A shaft 126 of the drive motor 124 is coupled to an upper face 131 side of the flat screw 130. The drive motor 124 is controlled by the control unit 180.

The flat screw 130 has a substantially columnar shape in which a size in a direction of a rotational axis RA is smaller than a size in a direction orthogonal to the direction of the rotational axis RA. In the illustrated example, the rotational axis RA is parallel to the Z axis. The flat screw 130 is rotated around the rotational axis RA by a torque generated by the drive motor 124.

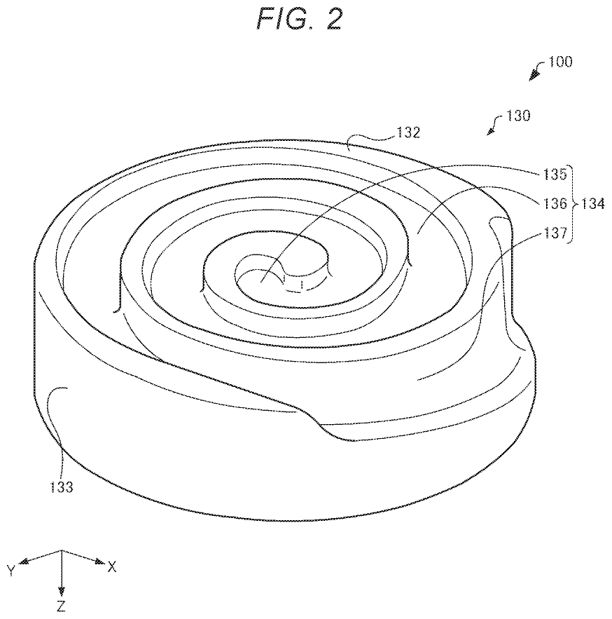

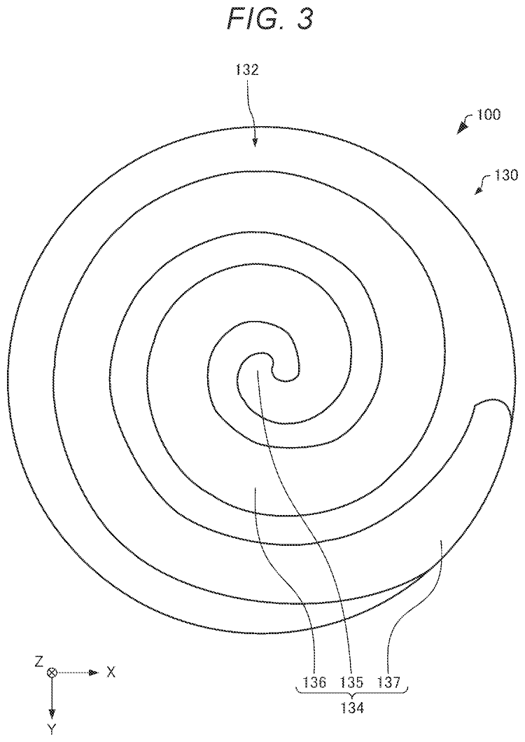

The flat screw 130 has an upper face 131, a grooved face 132 at an opposite side to the upper face 131, and a side face 133 that couples the upper face 131 to the grooved face 132. The grooved face 132 is provided with a first groove 134. Here, FIG. 2 is a perspective view schematically showing the flat screw 130. FIG. 3 is a plan view schematically showing the flat screw 130. Note that FIGS. 2 and 3 show a state in which the up-and-down positional relationship is reversed to that of the state shown in FIG. 1 for the sake of convenience.

As shown in FIGS. 2 and 3, the first groove 134 of the flat screw 130 includes, for example, a central portion 135, a coupling portion 136, and a material supply portion 137.

The central portion 135 is a portion opposed to a communication hole 146 provided in the barrel 140. The central portion 135 communicates with the communication hole 146. The shape of the central portion 135 is, for example, a circular shape when viewed from the Z-axis direction.

The coupling portion 136 is a portion that couples the central portion 135 to the material supply portion 137. In the illustrated example, the shape of the coupling portion 136 is a spiral shape swirling around the central portion 135 when viewed from the Z-axis direction. The coupling portion 136 is provided in a spiral shape from the central portion 135 toward the outer circumference of the grooved face 132.

The material supply portion 137 is a portion provided at the outer circumference of the grooved face 132. That is, the material supply portion 137 is a portion provided at the side face 133 of the flat screw 130. In other words, the material supply portion 137 is a portion where the side face 133 is opened, and is a portion viewable from the lateral side of the flat screw 130. The depth of the material supply portion 137 may be larger than the depth of the coupling portion 136. A material fed from the material feeding section 110 is supplied to the first groove 134 from the material supply portion 137. The supplied material passes through the coupling portion 136 and the central portion 135 and is supplied to the communication hole 146 provided in the barrel 140.

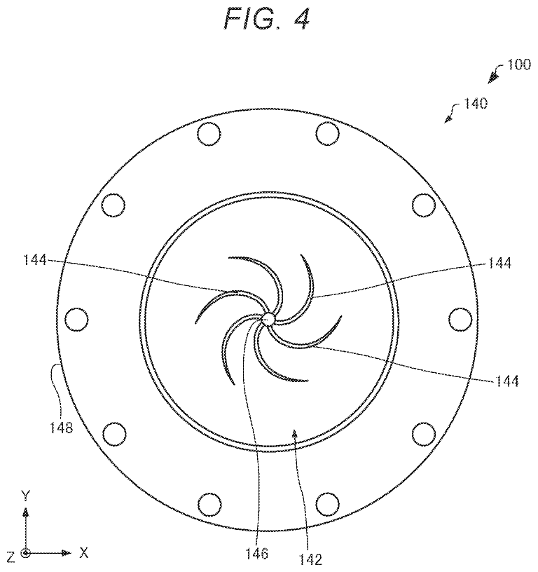

The barrel 140 is provided below the flat screw 130 as shown in FIG. 1. The barrel 140 has an opposed face 142 opposed to the grooved face 132 of the flat screw 130. At the center of the opposed face 142, the communication hole 146 is provided. The communication hole 146 communicates with a nozzle flow channel 172. Here, FIG. 4 is a plan view schematically showing the barrel 140.

In the opposed face 142 of the barrel 140, a second groove 144 and the communication hole 146 are provided as shown in FIG. 4. A plurality of second grooves 144 are provided. In the illustrated example, six second grooves 144 are provided, but the number thereof is not particularly limited. The plurality of second grooves 144 are provided around the communication hole 146 when viewed from the Z-axis direction. One end of the second groove 144 is coupled to the communication hole 146, and the second groove 144 extends in a spiral shape from the communication hole 146 toward an outer circumference 148 of the opposed face 142. The second groove 144 has a function of guiding the molten material to the communication hole 146. The shape of the second groove 144 is not particularly limited, and may be, for example, a linear shape. In addition, since the molten material can be effectively guided to the communication hole 146, it is preferred to provide the second groove 144 in the opposed face 142, but the second groove 144 need not be provided in the opposed face 142.

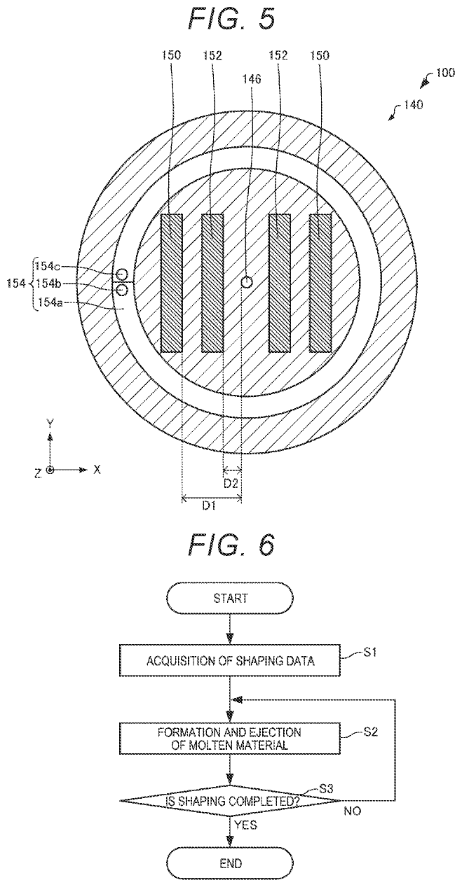

The first heating section 150 and the second heating section 152 are provided inside the barrel 140 as shown in FIG. 1. The heating sections 150 and 152 heat the material supplied to the first groove 134 from the material feeding section 110. The temperature of the first heating section 150 is lower than the temperature of the second heating section 152. The temperature of the first heating section 150 is, for example, lower than the melting point of the material to be supplied. The temperature of the second heating section 152 is, for example, equal to or higher than the melting point of the material to be supplied. Here, FIG. 5 is a cross-sectional view taken along the line V-V of FIG. 1 schematically showing the three-dimensional shaping apparatus 100.

The first heating section 150 and the second heating section 152 are each, for example, a bar heater as shown in FIG. 5. The heating sections 150 and 152 each may be a ceramic heater or a heating wire heater. In the illustrated example, two first heating sections 150 and two second heating sections 152 are provided. Between the two first heating sections 150, the communication hole 146 and the two second heating sections 152 are located. Between the two second heating sections 152, the communication hole 146 is located.

A distance D1 between the first heating section 150 and the communication hole 146 is larger than a distance D2 between the second heating section 152 and the communication hole 146. The distance D1 is the shortest distance between the first heating section 150 and the communication hole 146. The distance D2 is the shortest distance between the second heating section 152 and the communication hole 146. The number of heating sections included in the three-dimensional shaping apparatus 100 is not particularly limited. For example, the three-dimensional shaping apparatus 100 may include a third heating section in addition to the first heating section 150 and the second heating section 152. Further, the second heating section 152 need not be provided as long as the first heating section 150 is provided.

The cooling section 154 is provided inside the barrel 140. The cooling section 154 includes, for example, a cooling flow channel 154a, an inlet 154b, and an outlet 154c. In the illustrated example, the cooling flow channel 154a is provided along the outer circumference of the barrel 140. The cooling flow channel 154a is provided so as to surround the communication hole 146 and the heating sections 150 and 152 when viewed from the Z-axis direction. The cooling section 154 cools the material supplied to the first groove 134 from the material feeding section 110. By the heating sections 150 and 152 and the cooling section 154, a temperature gradient is formed such that the temperature gradually increases from the outside to the inside of the barrel 140.

Into the cooling flow channel 154a, a refrigerant is introduced from the inlet 154b. The refrigerant introduced from the inlet 154b flows through the cooling flow channel 154a and is discharged from the outlet 154c. Although not illustrated, the cooling section 154 includes a refrigerant circulation device coupled to the inlet 154b and the outlet 154c. The refrigerant circulation device circulates the refrigerant from the outlet 154c to the inlet 154b while cooling the refrigerant. Examples of the refrigerant include water and industrial water.

A place where the heating sections 150 and 152 and the cooling section 154 are provided is not particularly limited. The heating sections 150 and 152 and the cooling section 154 may be provided in the screw case 122 or in the flat screw 130.

The temperature sensor 160 is provided in the barrel 140 as shown in FIG. 1. In the illustrated example, the temperature sensor 160 is provided closer to the side face 133 side than to the central side of the flat screw 130. Although not illustrated, the temperature sensor 160 may be provided in the communication hole 146 of the barrel 140. The temperature sensor 160 measures the temperature of the first groove 134. The temperature sensor 160 measures, for example, the temperature of the material supply portion 137 of the first groove 134. In the illustrated example, the temperature sensor 160 measures the temperature of the first groove 134 via the temperature of the barrel 140. The temperature sensor 160 is, for example, a thermocouple, a thermistor, an infrared sensor, or the like. The number of temperature sensors 160 is not particularly limited.

The nozzle 170 is provided below the barrel 140. The nozzle 170 ejects the molten material supplied from the plasticizing section 120 toward the stage 20. In the nozzle 170, the nozzle flow channel 172 and a nozzle hole 174 are provided. The nozzle flow channel 172 communicates with the communication hole 146. The nozzle hole 174 communicates with the nozzle flow channel 172. The nozzle hole 174 is an opening provided in a tip portion of the nozzle 170. The planar shape of the nozzle hole 174 is, for example, a circular shape. The molten material supplied to the nozzle flow channel 172 from the communication hole 146 is ejected from the nozzle hole 174.

The control unit 180 is constituted by, for example, a computer including a processor, a main storage device, and an input/output interface for performing signal input/output to/from the outside. The control unit 180, for example, exhibits various functions by execution of a program read on the main storage device by the processor. The control unit 180 controls the drive motor 124, the heating sections 150 and 152, the cooling section 154, and the moving mechanism 30. The control unit 180 may be constituted by a combination of a plurality of circuits not by a computer.

### 1.3. Shaping Process

Next, a shaping process of the three-dimensional shaping apparatus 100 according to the present embodiment will be described. FIG. 6 is a flowchart for illustrating the shaping process of the three-dimensional shaping apparatus 100 according to the present embodiment. The control unit 180 starts the shaping process for shaping a three-dimensional shaped article OB when receiving a predetermined start operation. Hereinafter, the shaping process of the control unit 180 will be sequentially described.

### 1.3.1. Step S1

First, the control unit 180 performs a process for acquiring shaping data for shaping the three-dimensional shaped article OB as shown in FIG. 6. The shaping data are data that represent information about the movement path of the nozzle 170 with respect to the shaping face 22 of the stage 20, the amount of the molten material to be ejected from the nozzle 170, the rotation speed of the flat screw 130, the temperatures of the heating sections 150 and 152, the temperature of the cooling section 154, and the like.

The shaping data are generated by, for example, slicer software installed on the computer coupled to the three-dimensional shaping apparatus 100. The slicer software generates the shaping data by, for example, reading shape data representing the shape of the three-dimensional shaped article OB generated using 3D CAD (Computer-Aided Design) software or 3D CG (Computer Graphics) software, and dividing the shape of the three-dimensional shaped article OB into layers having a predetermined thickness. The shape data read by the slicer software are data of an STL (Standard Triangulated Language) format, an IGES (Initial Graphics Exchange Specification) format, an STEP (Standard for the Exchange of Product) format, or the like. The shaping data generated by the slicer software are represented by a G-code, an M-code, or the like. The control unit 180 acquires the shaping data from the computer coupled to the three-dimensional shaping device 100 or a recording medium such as a USB (Universal Serial Bus) memory.

### 1.3.2. Step S2

Subsequently, the control unit 180 performs a process for forming a molten material and ejecting the formed molten material. Specifically, first, the control unit 180 controls the rotation of the flat screw 130, the temperatures of the heating sections 150 and 152, and the temperature of the cooling section 154 based on the acquired shaping data, thereby plasticizing a material and forming a molten material.

By the rotation of the flat screw 130, the material fed from the material feeding section 110 is supplied to the first groove 134 from the material supply portion 137 of the flat screw 130. The material introduced into the first groove 134 is conveyed to the central portion 135 along the path of the first groove 134. While being conveyed through the first groove 134, the material is melted by shearing due to the relative rotation of the flat screw 130 to the barrel 140, and heating by the heating sections 150 and 152, and transformed into a molten material in a paste form having fluidity. The molten material collected at the central portion 135 is pressure-fed to the nozzle 170 from the communication hole 146.

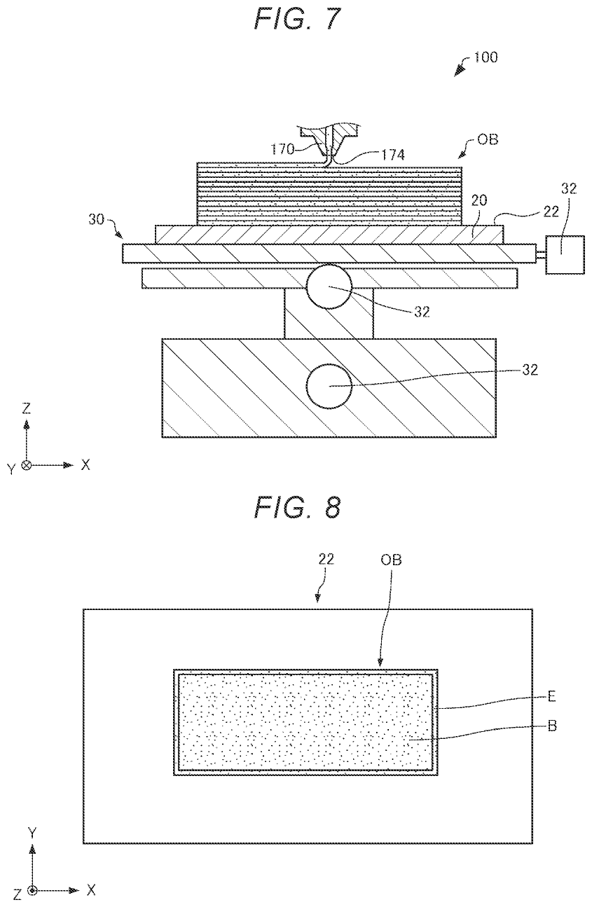

Subsequently, as shown in FIG. 7, the control unit 180 performs a process for ejecting the molten material to the shaping face 22 from the nozzle 170 while changing the relative position of the nozzle 170 to the shaping face 22 by controlling the moving mechanism 30 based on the acquired shaping data. By doing this, for example, a first layer of the three-dimensional shaped article OB is shaped. Note that FIG. 7 is a view for illustrating the shaping process of the three-dimensional shaping apparatus 100, and schematically shows a manner of shaping the three-dimensional shaped article OB by the three-dimensional shaping apparatus 100.

In Step S2, the control unit 180 performs a first process for rotating the flat screw 130 at a first rotation speed by controlling the drive motor 124 based on the shaping data. The control unit 180 controls the first heating section 150 so that the temperature measured by the temperature sensor 160 falls within a predetermined range when performing the first process. Specifically, the control unit 180 controls the first heating section 150 at a first temperature when performing the first process. The control unit 180 controls the first heating section 150 so that the temperature of the first heating section 150 becomes the first temperature when performing the first process.

In Step S2, the control unit 180 further performs a second process for rotating the flat screw 130 at a second rotation speed higher than the first rotation speed by controlling the drive motor 124 based on the shaping data. The control unit 180 controls the first heating section 150 so that the temperature measured by the temperature sensor 160 falls within a predetermined range when performing the second process. Specifically, the control unit 180 controls the first heating section 150 at a second temperature lower than the first temperature when performing the second process. The control unit 180 controls the first heating section 150 so that the temperature of the first heating section 150 becomes the second temperature when performing the second process.

The control unit 180 controls, for example, the cooling section 154 in addition to the control of the first heating section 150 when performing the first process and the second process. According to this, the temperature measured by the temperature sensor 160 can be adjusted to the second temperature in a shorter time when performing the second process.

The control unit 180 controls, for example, the temperature of the first heating section 150 within a range lower than the glass transition temperature of the material while maintaining the temperature of the second heating section 152 at a temperature equal to or higher than the glass transition temperature of the material when performing the first process and the second process. According to this, in the material supply portion 137 of the first groove 134, the material can be easily brought to a solid state, and in the communication hole 146, the material can be easily brought to a molten state.

The control unit 180 may read out a table that specifies the rotation speed of the flat screw 130 and the temperature of the first heating section 150 and determine the first temperature and the second temperature based on the table when performing the first process and the second process. The table may be stored in a storage unit (not shown). The first temperature and the second temperature may be appropriately determined based on the material to be supplied.

Here, FIG. 8 is a view for illustrating the shaping process of the three-dimensional shaping apparatus 100, and is a plan view schematically showing the three-dimensional shaped article OB at the time point when shaping of the first layer is finished by the three-dimensional shaping apparatus 100. As shown in FIG. 8, the control unit 180, for example, performs the first process when shaping an outer edge E of the three-dimensional shaped article OB, and performs the second process when shaping an internal portion B of the three-dimensional shaped article OB.

### 1.3.3. Step S3

Subsequently, as shown in FIG. 6, the control unit 180 performs a process for determining whether or not shaping of all the layers of the three-dimensional shaped article OB is completed based on the acquired shaping data. When it is not determined that shaping of all the layers of the three-dimensional shaped article OB is completed (“NO” in Step S3), the control unit 180 returns to Step S2 and shapes, for example, a second layer of the three-dimensional shaped article OB. On the other hand, when it is determined that shaping of all the layers of the three-dimensional shaped article OB is completed (“YES” in Step S3), the control unit 180 finishes the shaping process. The control unit 180 shapes the three-dimensional shaped article OB by repeatedly performing the processes of Step S2 and Step S3 until it is determined that shaping of all the layers of the three-dimensional shaped article OB is completed in Step S3.

The first process and the second process may be performed when shaping each of all the layers of the three-dimensional shaped article OB, or may be performed when shaping any of the layers of the three-dimensional shaped article OB. Further, the first process and the second process may be performed when shaping different layers of the layers of the three-dimensional shaped article OB. For example, the first process may be performed for the first layer of the layers of the three-dimensional shaped article OB, and the second process may be performed for the second layer of the layers of the three-dimensional shaped article OB.

### 1.4. Operational Effects

In the plasticizing section 120, the control unit 180 performs the first process for rotating the flat screw 130 at the first rotation speed by controlling the drive motor 124 and the second process for rotating the flat screw 130 at the second rotation speed higher than the first rotation speed by controlling the drive motor 124. Further, the control unit 180 controls the first heating section 150 so that the temperature measured by the temperature sensor 160 falls within a predetermined range when performing the first process and the second process.

Here, the following formula (1) is an energy equation in consideration of heat transfer, heat conduction, and shear heat generation due to movement of the molten material.

ρcₚ·DT/Dt=κ∇²T+ηγ² (1)

ρ: density, cₚ: specific heat, κ: thermal conductivity, η: viscosity, γ: shear rate

The increase in temperature due to shear heat generation is as represented by the following formula (2).

$$\frac{D T}{D t} = \frac{η {\dot{γ}}^{2}}{ρ {c}_{p}} \qquad ( 2 )$$

According to the document “PRINCIPLES OF POLYMER PROCESSING” (written by Z. Tadmor and C. G. Gogos), the shear flow rate in a rectangular tube is as represented by the following formula (3).

$${Q}_{d} = \frac{{V}_{bz}}{2} \times WH \times {F}_{d} \qquad ( 3 )$$

Note that in the formula (3), V_{bz} is a component along the direction of travel in the rectangular tube of a barrel velocity. W is a rectangular tube width, and H is a rectangular tube height. F_{d} is a shape factor and is represented by the following formula (4), and is a function of the rectangular tube shape W and H.

$${F}_{d} = \frac{16 W}{{π}^{3} H} {\sum }_{i = 1 , 3 , 5}^{∞} \frac{1}{{i}^{3}} tanh ( \frac{i π H}{2 W} ) \qquad ( 4 )$$

When the spiral angle of the groove provided in the flat screw is represented by θ, V_{bz} is a cosθ component of the circumferential speed V_{b} of the barrel and is represented by the following formula (5).

$${V}_{b z} = {V}_{b} cos θ = \frac{2 π N}{60} r cos θ \qquad ( 5 )$$

In the flat screw, the radius r is not limited to a barrel outer radius, and is a radius at an arbitrary position of the coupling portion of the groove provided in the flat screw. According to the formula (5), the circumferential speed of the flat screw decreases as approaching the central portion of the groove.

The shear rate depends on the rotation speed of the flat screw 130, and therefore, according to the formula (2), as the rotation speed is higher, the increase in temperature due to shear heat generation becomes larger.

As described above, in the plasticizing section 120, the control unit 180 controls the first heating section 150 so that the temperature measured by the temperature sensor 160 falls within a predetermined range when performing the first process and the second process. Therefore, as compared with a case where the control unit does not control the first heating section so that the temperature measured by the temperature sensor falls within a predetermined range, even if the second process for rotating the flat screw at the second rotation speed higher than the first rotation speed is performed, an increase in the temperature of the first groove 134 in the vicinity of the outer circumference of the flat screw 130 where the shear rate becomes particularly high can be suppressed. According to this, a material in a solid state is easily supplied to the first groove 134, and the material can be stably plasticized. As a result, a bridge phenomenon in which a new material is not supplied due to leakage of a molten material out of the flat screw 130 can be prevented. The pressure in the material supply portion 137 of the first groove 134 is smaller than the pressure in the coupling portion 136 of the first groove 134, and therefore, when a material is melted in the material supply portion 137, the material easily leaks out of the flat screw 130.

In the plasticizing section 120, the temperature sensor 160 is provided in the barrel 140. Therefore, in the plasticizing section 120, the temperature of the first groove 134 can be measured via the temperature of the barrel 140.

In the plasticizing section 120, the control unit 180 controls the first heating section 150 at the first temperature when performing the first process, and controls the first heating section 150 at the second temperature lower than the first temperature when performing the second process. Therefore, in the plasticizing section 120, as compared with a case where the first heating section is not controlled when performing the second process, an increase in the temperature of the first groove 134 in the vicinity of the outer circumference of the flat screw 130 can be suppressed.

In the plasticizing section 120, the second heating section 152 that heats the material supplied to the first groove 134 is included, and the distance D1 between the first heating section 150 and the communication hole 146 is larger than the distance D2 between the second heating section 152 and the communication hole 146. Therefore, the control unit 180 of the plasticizing section 120 can control the first heating section 150 in the first process and the second process while maintaining the temperature of the second heating section 152 at a temperature equal to or higher than the glass transition temperature of the material. According to this, the molten material is easily supplied to the communication hole 146.

In the plasticizing section 120, the first groove 134 is provided in the central portion 135 opposed to the communication hole 146 and the outer circumference of the grooved face 132, and includes the material supply portion 137 to be supplied with the material, and the coupling portion 136 that couples the central portion 135 to the material supply portion 137. Therefore, in the plasticizing section 120, an increase in the temperature of the material supply portion 137 can be suppressed by the first process and the second process.

In the three-dimensional shaping apparatus 100, the control unit 180 performs the first process when shaping the outer edge E of the three-dimensional shaped article OB, and performs the second process when shaping the internal portion B of the three-dimensional shaped article OB. In the first process, the rotation speed of the flat screw 130 is lower than in the second process, and therefore, the amount of the molten material ejected from the plasticizing section 120 is small. Accordingly, in the three-dimensional shaping apparatus 100, the internal portion B that is not visible can be shaped in a short time by the second process while shaping the outer edge E that is visible with high accuracy by the first process.

### 2. Modifications of Three-Dimensional Shaping Apparatus

### 2.1. First Modification

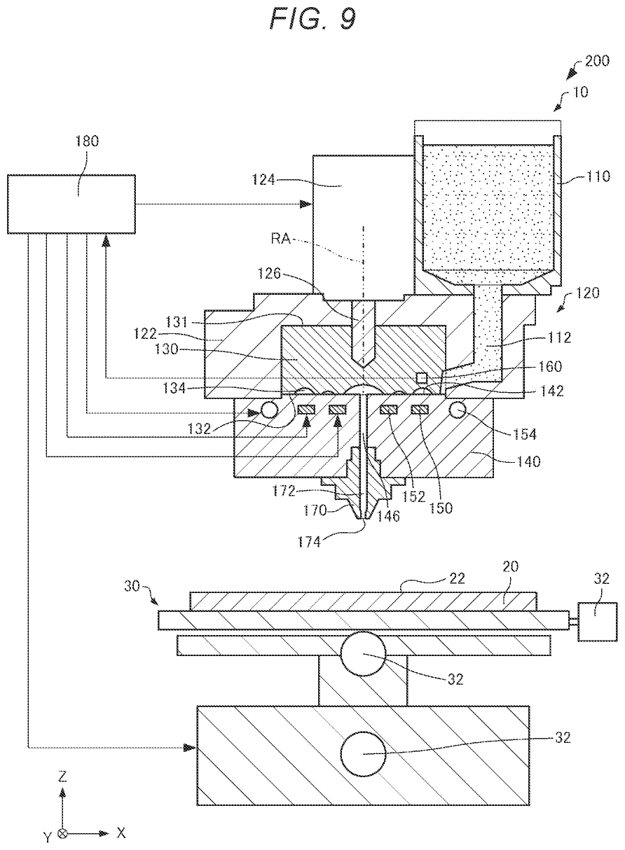

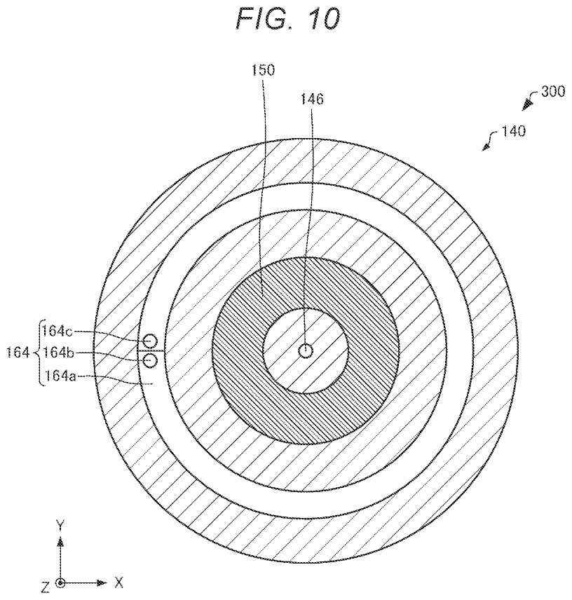

Next, a three-dimensional shaping apparatus according to a first modification of the present embodiment will be described with reference to the drawing. FIG. 9 is a cross-sectional view schematically showing a three-dimensional shaping apparatus 200 according to the first modification of the present embodiment.

Hereinafter, in the three-dimensional shaping apparatus 200 according to the first modification of the present embodiment, members having the same function as the constituent members of the three-dimensional shaping apparatus 100 according to the present embodiment described above are denoted by the same reference numerals, and a detailed description thereof is omitted. The same also applies to three-dimensional shaping apparatuses according to second to sixth modifications of the present embodiment described below.

In the three-dimensional shaping apparatus 100 described above, as shown in FIG. 1, the temperature sensor 160 is provided in the barrel 140.

On the other hand, in the three-dimensional shaping apparatus 200, as shown in FIG. 9, the temperature sensor 160 is provided in the flat screw 130. Therefore, in the three-dimensional shaping apparatus 200, the temperature of the first groove 134 can be measured via the temperature of the flat screw 130.

The place where the temperature sensor 160 is provided is not particularly limited as long as the temperature of the first groove 134 can be measured. The temperature sensor 160 may be provided, for example, in the screw case 122.

### 2.2. Second Modification

Next, a three-dimensional shaping apparatus according to a second modification of the present embodiment will be described with reference to the drawing. FIG. 10 is a plan view schematically showing the barrel 140 of a three-dimensional shaping apparatus 300 according to the second modification of the present embodiment.

In the three-dimensional shaping apparatus 100 described above, as shown in FIG. 5, the first heating section 150 is a bar heater.

On the other hand, in the three-dimensional shaping apparatus 300, as shown in FIG. 10, the first heating section 150 is a ring heater. The shape of the first heating section 150 is a shape surrounding the communication hole 146 when viewed from the Z-axis direction. In the illustrated example, the shape of the first heating section 150 is an annular shape. The center of the first heating section 150 is located in the communication hole 146. Although not illustrated, the three-dimensional shaping apparatus 300 may include a second heating section that is a ring heater. In that case, the first heating section 150 is provided so as to surround the second heating section.

In the three-dimensional shaping apparatus 300, the shape of the first heating section 150 is a shape surrounding the communication hole 146 when viewed from the Z-axis direction. Therefore, in the three-dimensional shaping apparatus 300, the temperature outside the first heating section 150 can be made lower than the temperature inside the first heating section 150. According to this, a temperature gradient such that the temperature gradually increases from the outside to the inside of the barrel 140 can be easily formed.

Further, in order to easily form the temperature gradient such that the temperature gradually increases from the outside to the inside of the barrel 140, the shape of the first heating section 150 is more preferably an annular shape surrounding the communication hole 146 when viewed from the Z-axis direction, however, the shape of the first heating section 150 may be a polygonal shape surrounding the communication hole 146 when viewed from the Z-axis direction, and may be a polygonal shape close to an annular shape such as an octagonal shape or a decagonal shape. Also in that case, the temperature gradient of the barrel 140 can be easily formed in the same manner.

### 2.3. Third Modification

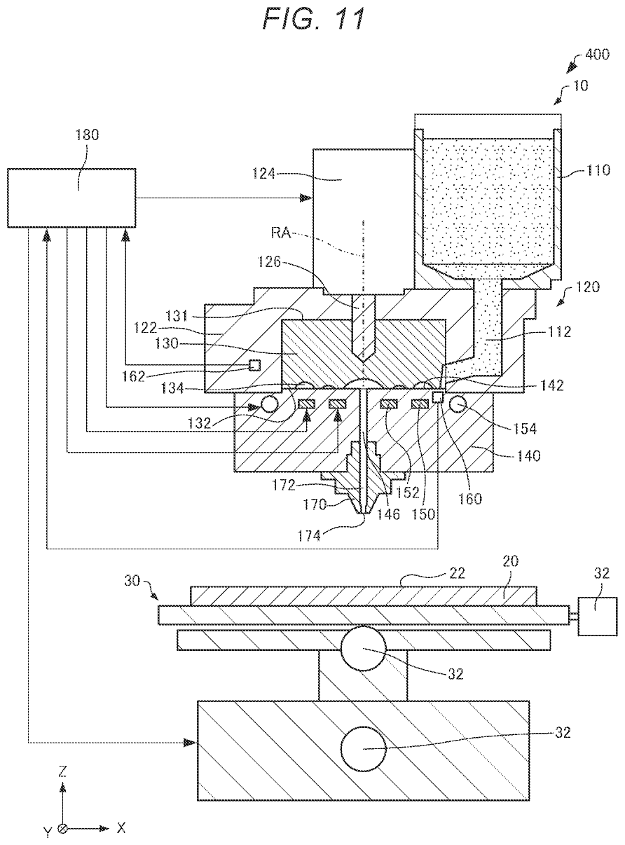

Next, a three-dimensional shaping apparatus according to a third modification of the present embodiment will be described with reference to the drawing. FIG. 11 is a cross-sectional view schematically showing a three-dimensional shaping apparatus 400 according to the third modification of the present embodiment.

The three-dimensional shaping apparatus 400 is different from the three-dimensional shaping apparatus 100 described above in that the apparatus includes a rotation sensor 162 that measures the rotation speed of the flat screw 130 as shown in FIG. 11.

The control unit 180 determines whether or not the rotation speed of the flat screw 130 becomes the first rotation speed based on the measurement result of the rotation sensor 162 when performing the first process. When it is determined that the rotation speed of the flat screw 130 does not become the first rotation speed, the control unit 180 repeats the first process for controlling the drive motor 124 until it is determined that the rotation speed of the flat screw 130 becomes the first rotation speed.

The control unit 180 determines whether or not the rotation speed of the flat screw 130 becomes the second rotation speed based on the measurement result of the rotation sensor 162 when performing the second process. When it is determined that the rotation speed of the flat screw 130 does not become the second rotation speed, the control unit 180 repeats the second process for controlling the drive motor 124 until it is determined that the rotation speed of the flat screw 130 becomes the second rotation speed.

In the three-dimensional shaping apparatus 400, as described above, the control unit 180 determines whether or not the rotation speed of the flat screw 130 becomes the first rotation speed based on the measurement result of the rotation sensor 162 when performing the first process, and determines whether or not the rotation speed of the flat screw 130 becomes the second rotation speed based on the measurement result of the rotation sensor 162 when performing the second process. Therefore, in the three-dimensional shaping apparatus 400, the rotation speed of the flat screw 130 can be controlled with higher accuracy.

### 2.4. Fourth Modification

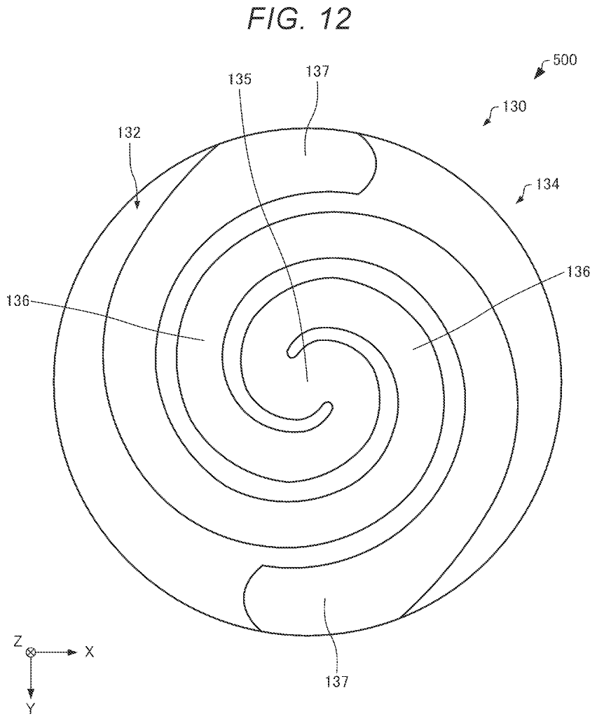

Next, a three-dimensional shaping apparatus according to a fourth modification of the present embodiment will be described with reference to the drawing. FIG. 12 is a plan view schematically showing the flat screw 130 of a three-dimensional shaping apparatus 500 according to the fourth modification of the present embodiment.

In the three-dimensional shaping apparatus 100 described above, as shown in FIG. 3, the first groove 134 includes one coupling portion 136 and one material supply portion 137.

On the other hand, in the three-dimensional shaping apparatus 500, as shown in FIG. 12, the first groove 134 includes a plurality of coupling portions 136 and a plurality of material supply portions 137. In the illustrated example, the first groove 134 includes two coupling portions 136 and two material supply portions 137. Note that the number of coupling portions 136 and the number of material supply portions 137 are not particularly limited.

### 2.5. Fifth Modification

Next, a three-dimensional shaping apparatus according to a fifth modification of the present embodiment will be described. In the three-dimensional shaping apparatus 100 described above, the first heating section 150 is controlled so that the temperature measured by the temperature sensor 160 falls within a predetermined range when performing the first process and the second process.

On the other hand, in the three-dimensional shaping apparatus according to the fifth modification of the present embodiment, the cooling section 154 is controlled so that the temperature measured by the temperature sensor 160 falls within a predetermined range when performing the first process and the second process. According to this, the material can be stably plasticized in the same manner as in the three-dimensional shaping apparatus 100.

### 2.6. Sixth Modification

Next, a three-dimensional shaping apparatus according to a sixth modification of the present embodiment will be described. In the three-dimensional shaping apparatus 100 described above, as the material for shaping the three-dimensional shaped article, ABS in a pellet form is used.

On the other hand, in the three-dimensional shaping apparatus according to the sixth modification of the present embodiment, as the material to be used in the plasticizing section 120, for example, a material containing any of various materials such as a material having thermoplasticity other than ABS, a metal material, and a ceramic material as a main material can be exemplified. Here, the “main material” means a material serving as a main component for forming the shape of the three-dimensional shaped article and refers to a material whose content ratio is 50 wt % or more in the three-dimensional shaped article. In the above-mentioned material, a material obtained by melting such a main material singly, and a material formed into a paste by melting some components contained together with the main material are included.

As the material having thermoplasticity, for example, a thermoplastic resin can be used. Examples of the thermoplastic resin include general-purpose engineering plastics such as polypropylene (PP), polyethylene (PE), polyacetal (POM), polyvinyl chloride (PVC), polyamide (PA), acrylonitrile-butadiene-styrene (ABS), polylactic acid (PLA), polyphenylene sulfide (PPS), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyether ether ketone (PEEK).

In the material having thermoplasticity, a pigment, a metal, a ceramic, or other than these, an additive such as a wax, a flame retardant, an antioxidant, or a heat stabilizer, or the like may be mixed. The material having thermoplasticity is plasticized and converted into a molten state by rotation of the flat screw 130 and heating by the heating sections 150 and 152 in the plasticizing section 120. The molten material formed in this manner is cured by lowering the temperature after being ejected from the nozzle 170.

The material having thermoplasticity is desirably ejected from the nozzle 170 in a completely molten state by being heated to a temperature equal to or higher than the glass transition temperature thereof. For example, ABS has a glass transition temperature of about 120° C. and the temperature thereof when it is ejected from the nozzle 170 is desirably about 200° C.

In the plasticizing section 120, in place of the above-mentioned material having thermoplasticity, for example, a metal material may be used as the main material. In that case, it is desirable that a component that melts when forming the molten material is mixed in a powder material obtained by pulverizing the metal material into a powder form, and the resulting material is fed to the plasticizing section 120.

Examples of the metal material include single metals of magnesium (Mg), iron (Fe), cobalt (Co), chromium (Cr), aluminum (Al), titanium (Ti), copper (Cu), and nickel (Ni), or alloys containing one or more of these metals, and a maraging steel, stainless steel, cobalt-chromium-molybdenum, a titanium alloy, a nickel alloy, an aluminum alloy, a cobalt alloy, and a cobalt-chromium alloy.

In the plasticizing section 120, in place of the above-mentioned metal material, a ceramic material can be used as the main material. Examples of the ceramic material include oxide ceramics such as silicon dioxide, titanium dioxide, aluminum oxide, and zirconium oxide, non-oxide ceramics such as aluminum nitride.

The powder material of the metal material or the ceramic material to be fed to the material feeding section 110 may be a mixed material obtained by mixing multiple types of single metal powders or alloy powders or ceramic material powders. Further, the powder material of the metal material or the ceramic material may be coated with, for example, any of the above-mentioned thermoplastic resins or any other thermoplastic resin. In that case, the material may be configured to exhibit fluidity by melting the thermoplastic resin in the plasticizing section 120.

To the powder material of the metal material or the ceramic material to be fed to the material feeding section 110, for example, a solvent can also be added. Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetyl acetone; alcohols such as ethanol, propanol, and butanol; tetra-alkyl ammonium acetates; sulfoxide-based solvents such as dimethyl sulfoxide and diethyl sulfoxide; pyridine-based solvents such as pyridine, γ-picoline, and 2,6-lutidine; tetra-alkyl ammonium acetates (for example, tetra-butyl ammonium acetate, etc.); and ionic liquids such as butyl carbitol acetate.

In addition thereto, for example, a binder may also be added to the powder material of the metal material or the ceramic material to be fed to the material feeding section 110. Examples of the binder include an acrylic resin, an epoxy resin, a silicone resin, a cellulosic resin, or another synthetic resin, or PLA (polylactic acid), PA (polyamide), PPS (polyphenylene sulfide), PEEK (polyether ether ketone), and other thermoplastic resins.

### 3. Injection Molding Apparatus

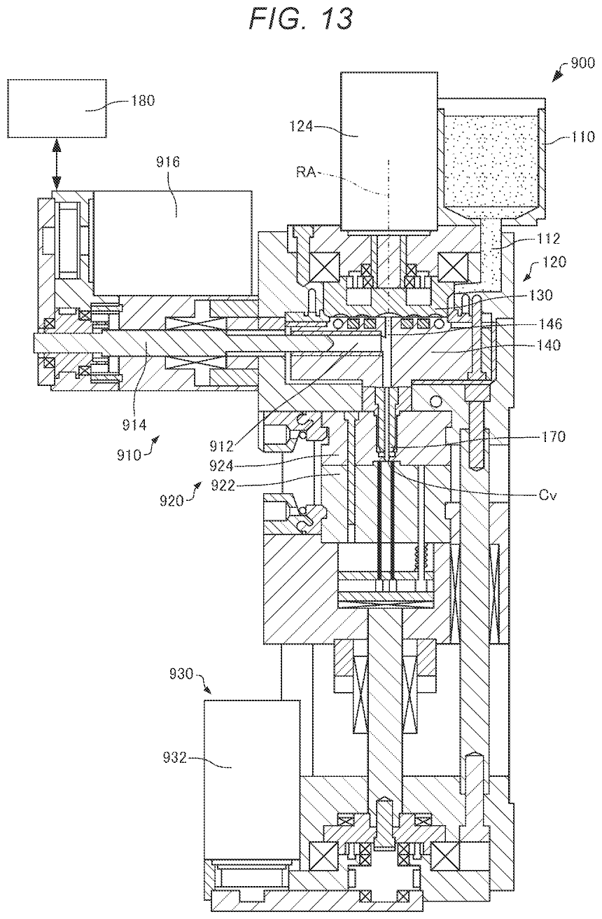

Next, an injection molding apparatus according to the present embodiment will be described with reference to the drawing. FIG. 13 is a cross-sectional view schematically showing an injection molding apparatus 900 according to the present embodiment.

The injection molding apparatus 900 includes, for example, the plasticizing section 120 described above as shown in FIG. 13. The injection molding apparatus 900 further includes, for example, a material feeding section 110, a nozzle 170, an injection mechanism 910, a mold portion 920, and a mold clamping device 930.

The plasticizing section 120 plasticizes a material supplied to the first groove 134 of the flat screw 130 to form a molten material in a paste form having fluidity, and guides the molten material to the injection mechanism 910 from the communication hole 146.

The injection mechanism 910 includes an injection cylinder 912, a plunger 914, and a plunger driving section 916. The injection mechanism 910 has a function of injecting the molten material in the injection cylinder 912 into a cavity Cv. The control unit 180 controls an injection amount of the molten material from the nozzle 170. The injection cylinder 912 is a member in a substantially cylindrical shape coupled to the communication hole 146 of the barrel 140. The plunger 914 slides inside the injection cylinder 912, and pressure-feeds the molten material in the injection cylinder 912 to the nozzle 170 coupled to the plasticizing section 120. The plunger 914 is driven by the plunger driving section 916 constituted by a motor.

The mold portion 920 includes a movable mold 922 and a fixed mold 924. The movable mold 922 and the fixed mold 924 are provided opposed to each other. Between the movable mold 922 and the fixed mold 924, the cavity Cv that is a space corresponding to the shape of a molded article is provided. The molten material is pressure-fed to the cavity Cv by the injection mechanism 910. The nozzle 170 ejects the molten material to the mold portion 920.

The mold clamping device 930 includes a mold driving section 932. The mold driving section 932 has a function of opening and closing the movable mold 922 and the fixed mold 924. The mold clamping device 930 drives the mold driving section 932 so as to move the movable mold 922 to open and close the mold portion 920.

The above-mentioned embodiments and modifications are examples, and the present disclosure is not limited thereto. For example, it is also possible to appropriately combine the respective embodiments and the respective modifications.

The present disclosure includes substantially the same configuration, for example, a configuration having the same function, method, and result, or a configuration having the same object and effect as the configuration described in the embodiments. Further, the present disclosure includes a configuration in which a part that is not essential in the configuration described in the embodiments is substituted. Further, the present disclosure includes a configuration having the same operational effect as the configuration described in the embodiments, or a configuration capable of achieving the same object as the configuration described in the embodiments. In addition, the present disclosure includes a configuration in which a known technique is added to the configuration described in the embodiments.

From the above-mentioned embodiments, the following contents are derived.

One aspect of a plasticizing device is directed to a plasticizing device that plasticizes a material, and includes
a drive motor,
a screw that is rotated by the drive motor and that has a grooved face provided with a groove,
a barrel that has an opposed face opposed to the grooved face and that is provided with a communication hole communicating with the groove at the opposed face,
a first heating section that heats the material supplied to the groove,
a temperature sensor that measures a temperature of the groove, and
a control unit that controls the drive motor and the first heating section, wherein
the control unit performs
   a first process for rotating the screw at a first rotation speed by controlling the drive motor, and
   a second process for rotating the screw at a second rotation speed higher than the first rotation speed by controlling the drive motor, and
the control unit controls the first heating section so that a temperature measured by the temperature sensor falls within a predetermined range when performing the first process and the second process.

According to the plasticizing device, as compared with a case where the first heating section is not controlled when performing the first process and the second process, even if the second process for rotating the screw at the second rotation speed higher than the first rotation speed is performed, an increase in the temperature of the groove in the vicinity of the outer circumference of the screw where the shear rate becomes particularly high can be suppressed. According to this, a material is easily supplied in a solid state to the groove, and the material can be stably plasticized.

In one aspect of the plasticizing device, the temperature sensor may be provided in the barrel.

According to the plasticizing device, the temperature of the groove can be measured via the temperature of the barrel.

In one aspect of the plasticizing device, the temperature sensor may be provided in the screw.

According to the plasticizing device, the temperature of the groove can be measured via the temperature of the screw.

In one aspect of the plasticizing device, the control unit may
control the first heating section at a first temperature when performing the first process, and
control the first heating section at a second temperature lower than the first temperature when performing the second process.

According to the plasticizing device, as compared with a case where the first heating section is not controlled when performing the second process, an increase in the temperature of the groove in the vicinity of the outer circumference of the screw can be suppressed.

In one aspect of the plasticizing device,
a second heating section that heats the material supplied to the groove may be included, and
a distance between the first heating section and the communication hole may be larger than a distance between the second heating section and the communication hole.

According to the plasticizing device, the control unit can control the first heating section in the first process and the second process while maintaining the temperature of the second heating section at a temperature equal to or higher than the glass transition temperature of the material.

In one aspect of the plasticizing device, a shape of the first heating section may be a shape surrounding the communication hole when viewed from a rotational axis direction of the screw.

According to the plasticizing device, the temperature outside the first heating section can be made lower than the temperature inside the first heating section, and a temperature gradient such that the temperature gradually increases from the outside to the inside of the barrel can be easily formed.

In one aspect of the plasticizing device,
a rotation sensor that measures a rotation speed of the screw may be included, and
the control unit may
   determine whether or not the rotation speed of the screw becomes the first rotation speed based on the measurement result of the rotation sensor when performing the first process, and
   determine whether or not the rotation speed of the screw becomes the second rotation speed based on the measurement result of the rotation sensor when performing the second process.

According to the plasticizing device, the rotation speed of the screw can be controlled with higher accuracy.

In one aspect of the plasticizing device, the groove may include
a central portion opposed to the communication hole,
a material supply portion that is provided at an outer circumference of the grooved face and that is supplied with the material, and
a coupling portion that couples the central portion to the material supply portion.

According to the plasticizing device, an increase in the temperature of the material supply portion can be suppressed by the first process and the second process.

One aspect of a plasticizing device is directed to a plasticizing device that plasticizes a material, and includes
a drive motor,
a screw that is rotated by the drive motor and that has a grooved face provided with a groove,
a barrel that has an opposed face opposed to the grooved face and that is provided with a communication hole communicating with the groove at the opposed face,
a cooling section that cools the material supplied to the groove,
a temperature sensor that measures a temperature of the groove, and
a control unit that controls the drive motor and the cooling section, wherein
the control unit performs
   a first process for rotating the screw at a first rotation speed by controlling the drive motor, and
   a second process for rotating the screw at a second rotation speed higher than the first rotation speed by controlling the drive motor, and
the control unit controls the cooling section so that a temperature measured by the temperature sensor falls within a predetermined range when performing the first process and the second process.

According to the plasticizing device, the material can be stably plasticized.

One aspect of a three-dimensional shaping apparatus is directed to a three-dimensional shaping apparatus that shapes a three-dimensional shaped article, and includes
a plasticizing section that plasticizes a material to form a molten material, and
a nozzle that ejects the molten material supplied from the plasticizing section to a stage, wherein
the plasticizing section includes
   a drive motor,
   a screw that is rotated by the drive motor and that has a grooved face provided with a groove,
   a barrel that has an opposed face opposed to the grooved face and that is provided with a communication hole communicating with the groove at the opposed face,
   a heating section that heats the material supplied to the groove,
   a temperature sensor that measures a temperature of the groove, and
   a control unit that controls the drive motor and the heating section, and
the control unit performs
   a first process for rotating the screw at a first rotation speed by controlling the drive motor, and
   a second process for rotating the screw at a second rotation speed higher than the first rotation speed by controlling the drive motor, and
the control unit controls the heating section so that a temperature measured by the temperature sensor falls within a predetermined range when performing the first process and the second process.

According to the three-dimensional shaping apparatus, the material can be stably plasticized.

In one aspect of the three-dimensional shaping apparatus, the control unit may perform
the first process when shaping an outer edge of the three-dimensional shaped article, and
the second process when shaping an internal portion of the three-dimensional shaped article.

According to the three-dimensional shaping apparatus, the internal portion that is not visible can be shaped in a short time by the second process while shaping the outer edge that is visible with high accuracy by the first process.

One aspect of an injection molding apparatus includes
a plasticizing section that plasticizes a material to form a molten material, and
a nozzle that injects the molten material supplied from the plasticizing section to a mold, wherein
the plasticizing section includes
   a drive motor,
   a screw that is rotated by the drive motor and that has a grooved face provided with a groove,
   a barrel that has an opposed face opposed to the grooved face and that is provided with a communication hole communicating with the groove at the opposed face,
   a heating section that heats the material supplied to the groove,
   a temperature sensor that measures a temperature of the groove, and
   a control unit that controls the drive motor and the heating section, and
the control unit performs
   a first process for rotating the screw at a first rotation speed by controlling the drive motor, and
   a second process for rotating the screw at a second rotation speed higher than the first rotation speed by controlling the drive motor, and
   the control unit controls the heating section so that a temperature measured by the temperature sensor falls within a predetermined range when performing the first process and the second process.

According to the injection molding apparatus, the material can be stably plasticized.

What is claimed is:

1. A plasticizing device that plasticizes a material, comprising:
a drive motor;
a screw that is rotated by the drive motor and that has a grooved face provided with a groove;
a barrel that has an opposed face opposed to the grooved face and that is provided with a communication hole communicating with the groove at the opposed face;
a first heating section that heats the material supplied to the groove;
a temperature sensor that measures a temperature of the groove; and
a control unit that controls the drive motor and the first heating section, wherein
the control unit performs
a first process for rotating the screw at a first rotation speed by controlling the drive motor, and
a second process for rotating the screw at a second rotation speed higher than the first rotation speed by controlling the drive motor, and
the control unit controls the first heating section so that a temperature measured by the temperature sensor falls within a predetermined range when performing the first process and the second process.

2. The plasticizing device according to claim 1, wherein the temperature sensor is provided in the barrel.

3. The plasticizing device according to claim 1, wherein the temperature sensor is provided in the screw.

4. The plasticizing device according to claim 1, wherein the control unit
controls the first heating section at a first temperature when performing the first process, and
controls the first heating section at a second temperature lower than the first temperature when performing the second process.

5. The plasticizing device according to claim 1, further comprising a second heating section that heats the material supplied to the groove, wherein
a distance between the first heating section and the communication hole is larger than a distance between the second heating section and the communication hole.

6. The plasticizing device according to claim 1, wherein
a shape of the first heating section is a shape surrounding the communication hole when viewed from a rotational axis direction of the screw.

7. The plasticizing device according to claim 1, further comprising a rotation sensor that measures a rotation speed of the screw, wherein
the control unit
determines whether or not the rotation speed of the screw becomes the first rotation speed based on the measurement result of the rotation sensor when performing the first process, and
determines whether or not the rotation speed of the screw becomes the second rotation speed based on the measurement result of the rotation sensor when performing the second process.

8. The plasticizing device according to claim 1, wherein
the groove includes
a central portion opposed to the communication hole,
a material supply portion that is provided at an outer circumference of the grooved face and that is supplied with the material, and
a coupling portion that couples the central portion to the material supply portion.

9. A plasticizing device that plasticizes a material, comprising:
a drive motor;
a screw that is rotated by the drive motor and that has a grooved face provided with a groove;
a barrel that has an opposed face opposed to the grooved face and that is provided with a communication hole communicating with the groove at the opposed face;
a cooling section that cools the material supplied to the groove;
a temperature sensor that measures a temperature of the groove; and
a control unit that controls the drive motor and the cooling section, wherein
the control unit performs
a first process for rotating the screw at a first rotation speed by controlling the drive motor, and
a second process for rotating the screw at a second rotation speed higher than the first rotation speed by controlling the drive motor, and
the control unit controls the cooling section so that a temperature measured by the temperature sensor falls within a predetermined range when performing the first process and the second process.

10. A three-dimensional shaping apparatus that shapes a three-dimensional shaped article, comprising:
a plasticizing section that plasticizes a material to form a molten material; and
a nozzle that ejects the molten material supplied from the plasticizing section to a stage, wherein
the plasticizing section includes
a drive motor,
a screw that is rotated by the drive motor and that has a grooved face provided with a groove,
a barrel that has an opposed face opposed to the grooved face and that is provided with a communication hole communicating with the groove at the opposed face,
a heating section that heats the material supplied to the groove,
a temperature sensor that measures a temperature of the groove, and
a control unit that controls the drive motor and the heating section, and
the control unit performs
a first process for rotating the screw at a first rotation speed by controlling the drive motor, and
a second process for rotating the screw at a second rotation speed higher than the first rotation speed by controlling the drive motor, and
the control unit controls the heating section so that a temperature measured by the temperature sensor falls within a predetermined range when performing the first process and the second process.

11. The three-dimensional shaping apparatus according to claim 10, wherein
the control unit performs
the first process when shaping an outer edge of the three-dimensional shaped article, and
the second process when shaping an internal portion of the three-dimensional shaped article.

12. An injection molding apparatus, comprising:
a plasticizing section that plasticizes a material to form a molten material; and
a nozzle that injects the molten material supplied from the plasticizing section to a mold, wherein the plasticizing section includes
a drive motor,
a screw that is rotated by the drive motor and that has a grooved face provided with a groove,
a barrel that has an opposed face opposed to the grooved face and that is provided with a communication hole communicating with the groove at the opposed face,
a heating section that heats the material supplied to the groove,
a temperature sensor that measures a temperature of the groove, and
a control unit that controls the drive motor and the heating section, and
the control unit performs
a first process for rotating the screw at a first rotation speed by controlling the drive motor, and
a second process for rotating the screw at a second rotation speed higher than the first rotation speed by controlling the drive motor, and
the control unit controls the heating section so that a temperature measured by the temperature sensor falls within a predetermined range when performing the first process and the second process.
